(19) United States
(12) Patent Application Publication
(10) Pub. No.: US 2012/0225604 A1
(43) Pub. Date: Sep. 6, 2012

(54) Systems and Methods for Tele-Interactive Toys and Games

(75) Inventors: Wolfgang Richter, Starnberg (DE); Faranak Zadeh, Vancouver (CA)

(73) Assignee: R2Z Innovations, Inc., Vancouver (CA)

(21) Appl. No.: 13/156,339

(22) Filed: Jun. 9, 2011

Related U.S. Application Data
(60) Provisional application No. 61/353,463, filed on Jun. 10, 2010.

(51) Int. Cl. A63H 3/00; G06F 15/16; A63H 33/00

(52) U.S. Cl. 446/175; 446/484; 446/268; 709/201

(57) ABSTRACT

This invention shows it is possible to use broadcast media to significantly enhance interactive learning or to entertain users while they play with toys or other games or play components. Signal sequences broadcast via the Internet, cable, satellite, or other media can invoke functions in toys while they are being used. These media broadcasts include shows, quizzes, educational or training movies, entertaining or scientific footages, and even broadcasts from radio stations.

As interactivity requires feedback, this will be provided by the user playing with the toys or other game devices either by forcing a reaction in the toys themselves or via communication lines into a network. This innovative manner of educating users while they play is provided by the invention's Interactive Play System (IPS). This system consists of hardware and software components and is able to mix “signal-2-function sequences” into any kind of broadcasting media content, whether it is live, streaming, or recorded.

### PRIORITY

This application claims priority to U.S. Provisional Application No. 61/353,463 filed on Jun. 10, 2010, the entire contents of which are incorporated herein by references.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### BRIEF SUMMARY OF THE INVENTION

The toy industry loses a huge amount of profit and customers to game consoles whose users are becoming younger every year, as they switch from normal toys to these interesting and entertaining electronic game devices. The interactivity of game consoles and the fact that a user can control them are the main reasons for their popularity. It seems interactivity is the key for successful marketing and product placement. When electronic toys first appeared on the market, they were equipped with buttons and some blinky lamps or LEDs, as well as some funny sound effects. Prospective buyers could buy and test these toys in a shop before buying them. The toy industry realized that users became bored with toys after a while and required ones with new effects. This changed when game consoles were introduced, they created virtual worlds where players could express their fantasies and control game situations in so many different ways that the fun and entertainment factor increased way above that of conventional toys. As this multibillion market grew, the toy industry had to find ways to bring its products up to date in a way that matched and even exceeded game consoles. This invention will empower this process in an affordable way because toys are much cheaper to produce than game consoles and come in much greater quantities for lower profit. This invention also takes care of the economic aspect by using existing components with the well-known bill of material (BOM) and total cost of ownership (TCO).

### The Invention's Underlying Solution

A broadcast station can mix signal sequences into a running program, which causes reactions in toys or game devices on the receiver's side by invoking functions in toys or games (FIG. 1). Interacting with toys, action figures, or game board pawns creates signals that can be led back into an analyzing device by using existing or new back channels, such as the Internet or telephone connections. The interactions from the user create signals that can be similar or different to those of game consoles and game pads, while playing. Also, play situations and the arrangement of toys or action figures or pawns create signals that can be analyzed or interpreted to fit the purpose of the broadcasted program. It is also possible for one user to control the toys of other users (far away) while playing, and vice versa. This invention enables a player to synthesize real-world action with broadcasted media for fun, learning, entertainment, or other purposes. This interactivity can include sporting activities, concentration activities, memory improvement, or reaction timing. The invention will use standard components that are well known in the toy industry, with additional functions in hardware and software. An Internet Personal Assistant Portal (PAP) will act as a switchboard between received contents and interactivity or feedback reactions. The invention also introduces the so-called Virtual Personal Assistant (VPA), software that supports each user while playing with the invention's underlying toys or game devices.

### State-of-the Art Review

A. Game consoles show interactive scenarios on TV or computer screens (PC games). A user has devices or means to manipulate the action for getting points or entering the next possible level. Such control devices (game pads) can have buttons and joysticks, accelerometers, or light sources that can be tracked from the game consoles' equipment. Platforms on the ground (digital weight scales and balance boards) give the user hands-free action as well as camera-monitored input devices that track the movements of users and players' bodies and limbs.

B. The toy market possesses toys, LCD, and board games with integrated electronics means for interactive feedback. Buttons or touch sensors check if a user is activating them to start some pre-programmed functions. Mechatronics is also available to move a toy's parts, heads, limbs, wheels, or whatever. Cars or other vehicles can be controlled remotely via radio frequency devices. All the described technologies can use the Internet for downloading and upgrading functions or playing online games in real time. This invention produces new ways for real-time interaction with broadcasted media content of any kind.

### The Invention's Underlying Hardware Concept

The microcontrollers that the toy industry uses often contain the means to produce sound, voice in- or output. This invention will show that it is possible to use such controllers additionally as input devices for gestures and/or signal sequences coming over a media at the same time with no large efforts in bill of material or controller performance.

A gesture recognition circuit replaces the need to use buttons, joysticks, or game pads. 3D gestures can be enabled by using several sensors, from capacitive (alternating e-fields) over light or sound (ultrasonic) or radar. The distance of a user's hand or finger from an electrode can be measured and transferred into signals for the microcontroller to analyze and react to. The controller starts functions related to the XYZ position of a user's finger or a pattern that the user is creating while playing with the toy/game. Functions can be started to move electromechanical components such as motors, servos, magnets, or other objects. So, it seems that the toy reacts to the users' input gestures. The XYZ coordinates or recognized gesture patterns can also be transferred into a network as control commands for online games or as reaction signs for broadcasting contents which a player watches while playing with the toy/game.

Signal sequences from the broadcast media (TV, radio, Internet, or others) can be received from the toy, and the controller inside starts related functions or activities as a kind of feedback. The user has now the order to react, either by giving gestures or gesture patterns or through voice commands or other comments into the toy. Means and sensors in the toy can receive these signals and return them into the network or invoke functions in the toy/game. The application part of the invention will demonstrate several examples.

### The Invention's Software Concept

A program or program sequence in the toy/game's microcontroller has the means to receive gestures or other signals from the user (player). These input signals can be converted into function codes or output signals. The function codes can call functions in the toy/game or outside by using communication technology for data transmission and reception. Signals can be calculated with formulas or compared in look-up tables that contain the reaction or function for every possible play/signal pattern. Signal sequences or patterns can be trained and stored in the toys/games' microcontrollers' memory. To identify the player or the toy, an ID code will be provided. The toys/games' microcontroller sends the ID code plus signal sequences or function codes to an Internet portal or to other electronic devices which can handle this information. The portal switches the ID/information sequence to a database and launches, the so-called Virtual Personal Assistant (VPA) software. This software reads or interprets commands from the database related to the ID code or sequences coming from the toy/game's microcontroller or from other electronic devices. It compares stored and received data and launches reaction activities for feedback to the user or the broadcasting station or to other sources.

A broadcasting station or a provider of digital or analog information can use the same portal (Personal Assistant Portal, PAP) to send sequences back to the user's toys in different ways. One way is to broadcast this information over broadcasting stations such as TV, radio, or other wired or wireless providers. The sequence can be any kind of electronic data, from audio to pictures or movie sequences to pure digital information or others. An activated toy on the receiving side (e.g. in front of a TV screen) receives such sequences and reacts immediately, so the player can play with this toy in relation to the content she/he is watching or listening.

The portal also creates a logbook for storing points for customer relationship management (CRM) purposes or other data that needs to be logged or stored in journals. Users can either register via telephone or via an Internet Web page (register page). The activities a Virtual Personal Assistant (VPA) should fulfill when triggered by external commands can be entered in an instruction page or as scripted with its own language (similar to mnemonics).

The functions of the Personal Assistant Portal (PAP) and the Virtual Personal Assistant (VPA) can also be used for sales support in a shop to promote a toy, game, or other games to a potential customer if he/she wants to touch them or act with them in a way that triggers the output activities from the VPA.

The state-of-the-art now presents TV screens with a built-in interactive Internet means (with apps) so the use of the TV in relation with the Personal Assistant Portal works as an additional service function for viewers, users, players, or other people who can access such a TV screen.

### Innovation-Related Energy Harvesting

Action figures or pawns for board games or the smallest toys are often too small to fit batteries inside them to power an internal circuit. If they have batteries inside, replacing them can be difficult. Most of these batteries are toxic, so it is not good for them to be in toys. The invention uses means and technologies to avoid the use of batteries whenever possible. Instead, they are replaced by energy harvesters (FIG. 3). The invention according to the preferred system works with alternating electric fields. This is useful, as such fields spread out over the human skin (dermis) in a reach of about one foot or more. If a user/player is influenced by such an alternating electric field, the devices he/she is close to or touches can be powered with this field and can also can give back data related to the invention's purposes or other purposes by using the electric field as a carrier for modulated or mixed data. Toys equipped with the invention's harvester often do not need a switch because they will be activated when they are touched or approached. The combination between interactivity, gesture, and/or energy harvesting creates an ideal hardware base for the innovation underlying technology and/or devices.

### The Invention Underlying Gesture Circuit

FIG. 2 and FIG. 5 show the schematic of a versatile gesture system that can be used for single or multi player scenarios and single or multi-gesture pattern recognition. It works with all kind of waves or fields that can be altered by human limbs. Such waves or fields include solar, infrared, sonar, electric fields, and others.

FIG. 2 and FIG. 5 shows an electric field version. A microcontroller M generates an alternating electric field on electrodes E1, E2, E3 or E4 in alternating sequences, so that there is always one electrode creating a field, while the others are either grounded internally by the microcontroller or externally, or floating against the microcontroller's open I/O port capacity, which can be in the range of a few pico-farads. Nearby the electrodes is the detector electrode, which can be in the shape of a small wire (or any other shape) or smaller than the emitting electrodes. If one of the electrodes emits the alternating electric field in a certain frequency (created from the microcontroller or other sources), the detector D receives a part of this field and rectifies the energy into a DC voltage. This voltage is led to a pulse generator P (or VCO or VCF), so that the pulse interval can be changed if the electric field is altered (e.g. by a user's or player's hand).

Users can absorb or bridge energy from the electric field that the detector senses. This invention allows for the use of all electrodes very narrowly together while other technologies, such as the capacitive touch screen, often have the electrodes in the corners. The pulse generator P and the detector D consist of only a few components, which is an important economic factor (low bill of material, BOM). A software in the microcontroller (described later in the software section of the invention) calculates the XYZ position of a user/player's hand and uses this for internal functions to move actors such as motors, servos, magnets or other electro mechanical components, as well as light (LED) or sound or voice output related to the user's actions.

Additionally, this signal can be transferred into a Personal Assistant Portal (PAP) (FIG. 1) network for interactivity related to multimedia content that a user is watching or listening to at the same time.

The controller M (of the toy) has the means for voice or sound or melody recognition, especially if the sound comes in pre-stored sequences. As the signals come in, the controller compares the received sequence with the stored ones to identify if they match in a frame of tolerance and accuracy, which can vary. If a match is detected, functions can be invoked with internal or external effects. Listing 1 shows how the gestures sensed and transferred (mixed with User/Toy ID).

### The Invention-Related Charge-and-Touch System

The microcontroller M of the toy creates an electric field, which spreads over the user's skin if she/he is near enough. If the user touches action figures, small toys, or pawns of a board game, these items will be influenced by the electric field. As this is an electrical signal, it can be rectified and charge a capacitor until a certain amount is reached. Then the electronics in the small items can be invoked and sends back signals or can start actions. The maximum voltage is created from the harvester if the user touches the device. So, it is possible to distinguish between approach and touch. FIG. 3 shows a harvester circuit for charge and touch as a principle schematic. An order (when a user/player is touching or arranging the items) determines the signal sequence, which can be sent back over the Personal Assistant Portal (PAP, FIG. 1) to a Virtual Personal Assistant (VPA). For example, a TV show reveals characters from a movie (e.g. Star Wars). The question now is who is responsible for special actions in a special scene? The user in the TV screen now has to touch the action figure from a set which must be the right one. If so, the Personal Assistant Portal (VPA) gives him points. The quiz master (the broadcasting station) sends back a sequence which can be received from at least one of the invention-related and equipped toys, which tells the user that he is right or wrong, what his points are, or other actions from sound or light effects or mechatronic movements.

### Description of Virtual Personal Assistant (VPA) Functions

VPA is a software set of functions resident in the input server of the invention's underlying system. Every time a trigger signal reaches the input server, a VPA is launched. This means that every user gets his/her own Virtual Personal Assistant (VPA), which “lives only for the current job” that needs to be done. An inherent artificial intelligence system (IAI) reduces the need for scripting and interpreting statements or comments. Tab. 1 shows a possible command list. A journal logs the activities automatically for reference, payment sharing or other purposes, among CRM, statistics, etc.

Interfacing with Game Consoles

The invention allows a simple interface with game consoles by using toys/games, board games, action figures, or other devices as input devices (game control, game pad, or others).

### Player Communication Unit

It is possible to equip the player/user with the invention's underlying devices that can inform him/her about the state of play or the game situation. It is preferable that such devices are worn like wristbands, headbands, caps, or other kinds of clothes, but they can also be stationary places near the play scene. In the same way that toys/games react to broadcasted signals, the player can get information on orders, points, signals, vibrations, or electromechanical support. Also a player/user can send back body signals or vital signs (EMG, ECG, EEG, movements, sounds, etc.) into the network or the Toy or Game.

### Signal-to-Function (S2F) Principle

S2F sequences can be broadcast over the normal communication media by using the possibilities that the media allows_audio signals, voice commands, color changing footage, or analog or digitals signals, even in combinations. A tele-interactive toy has the means to receive S2F sequences and the ability to check if they match with previous, stored ones and, if so, to launch determined functions to inform or entertain the user or viewers. This means it is necessary that the toy/game is within reach of media such as a TV screen, radio, or computer, which is connected to the Internet or other networks. The technology of the information clouds will enable S2F signals to be received everywhere in the near future. Such sequences can also address specific toys or games or groups of them by containing identifying signals. Special sequences can lock or unlock receiving devices (toys/games) or change functions.

### Use of Set-Up Boxes

The invention also allows integration into so-called set-up boxes, which provide content delivered via cable or satellite. Such boxes are often equipped with back channels, which can be used from the invention as well. Telephone or Internet or network connections can also be used.

### Time or Picture Frame-Related Interactivity

The content can be added with a list of functions started either at a specific time while the content is being broadcasted or when some determined pictures or film sequences occur. In this case a user's reaction will only be accepted during a time interval or specific picture sequence where the user has to act and play with his/her toys/games doing the right thing at the right time to get points or other benefits. In the short term, the right answer must come at the right time or for the right picture.

Preparing such content, a person can watch the film/audio/content/sequence in parts or frames with the invention-related software, and enter positions in time or picture numbers together with the sequence for function commands S2F in a list that will later run and work in synchronization with the broadcasted content. A VPA can also be triggered to interpret such a list.

### DESCRIPTION OF THE FIGURES

FIG. 1 gives an Overview over a complete system. Toys or Games are equipped with their Function Control Units (FCU) which is able to react on user movements and vital signs. It also checks for S2F sequences coming from Broadcast stations, Computers or Networks. Related data is handled in the Personal Assistant Portal (PAP) where an Input Server launches a Virtual Personal Assistant (VPA) to interpret (at least one) script(s) to generate various Feedback according the users input or other (trigger-)data. User data and VPA Scripts (JOBs) are stored in databases or files. Broadcast stations can transmit Signal-to-Function sequences (S2F) to Function Control Units (FCU). The PAP can also send such S2F's into Networks (like cable, telephone, and Internet).

FIG. 2 or FIG. 5 shows the Hardware principle of an FCU. The schematic in FIG. 5 describes a realized hardware, Listing 1 its software.

FIG. 3 shows a device (charge and touch Harvester) (CTH) swayed by an alternating electric field, which is attached from a generator over a users skin (dermis). This creates a kind of “synthetic aura” around the user. Any CTH nearby can rectify and buffer electrical energy out of such e-field, the more the close the user gets. If the user touches a CTH (integrated in Pawns or Action Figures or other devices), it receives the maximum voltage, which can be used to invoke various kind of Feedback from internal (LED, Sound, Mechatronic) to external (transmitting Id's, Function Codes or other signals). This includes also some information about the distance to FCU's, Player(s), or other CTH's, which allows to analyze and react on play/game situations.

FIG. 4 shows an arrangement of Electrodes (for e-field gesture detection) at a flexible foil (e.g. Polymer) which alleviates the assembling into a toy. Detector and Controller build a complete unit. Such a foil can be “wrapped” around (plastic-) skulls or bodies of Toys, like dogs or other animals, dolls, plush or other devices.

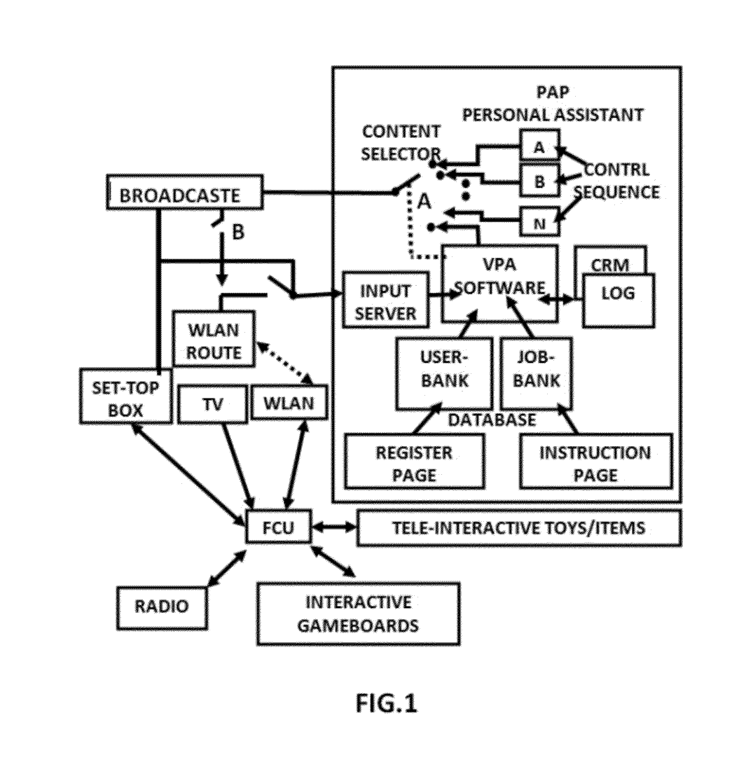

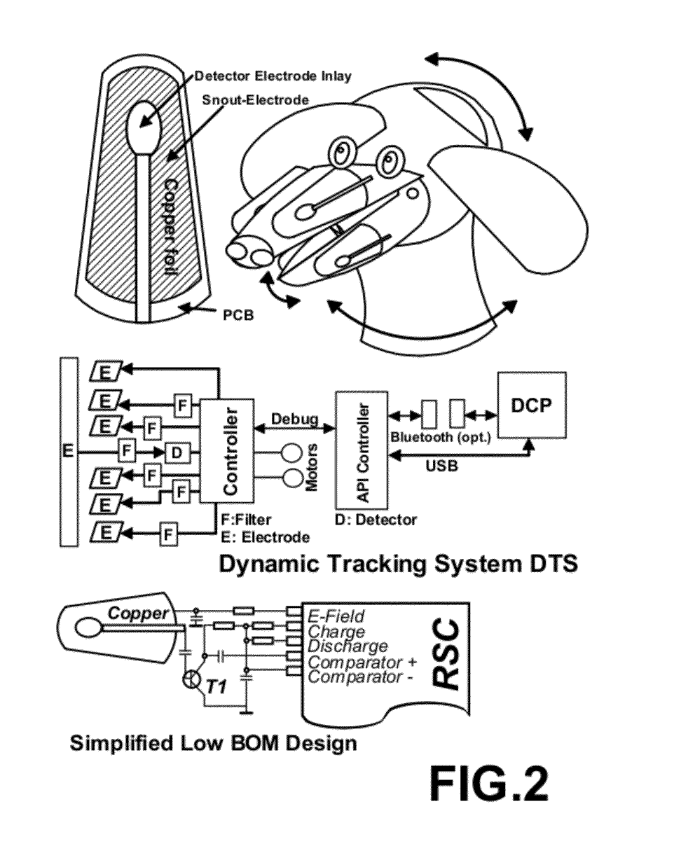

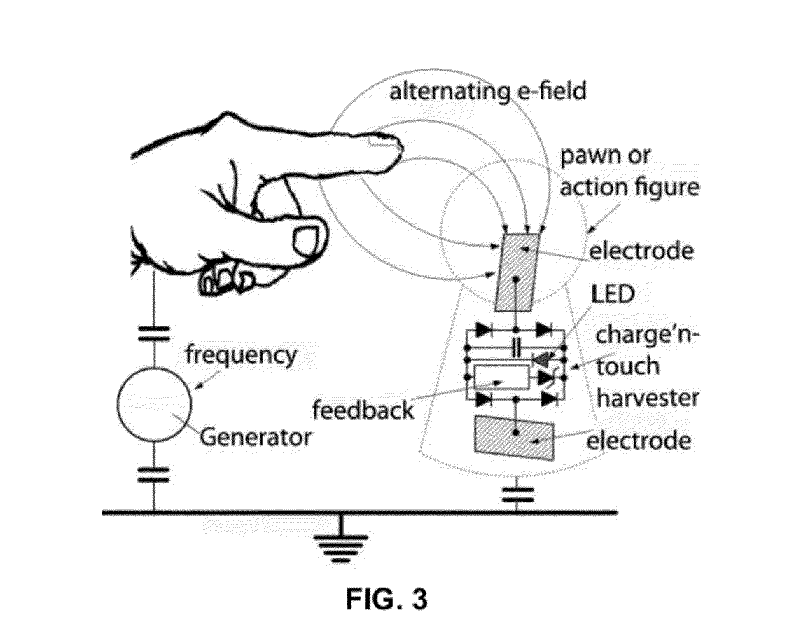

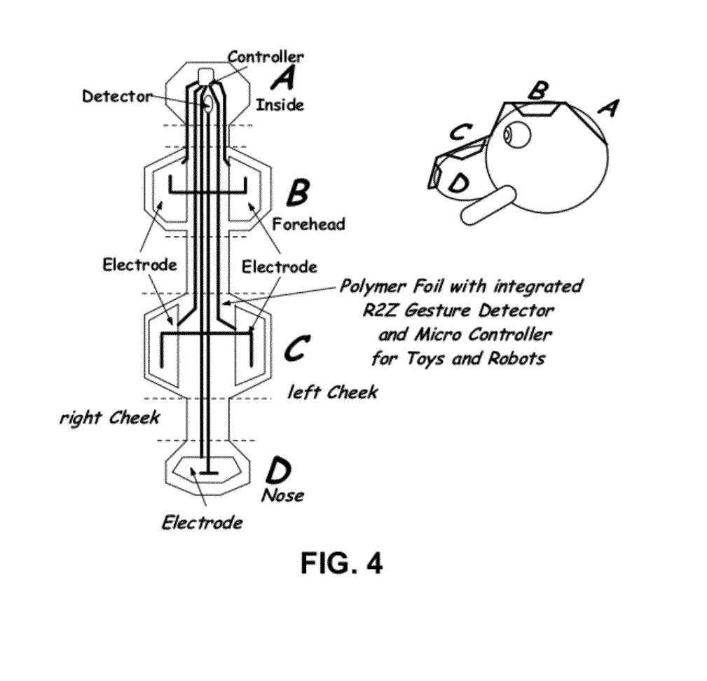

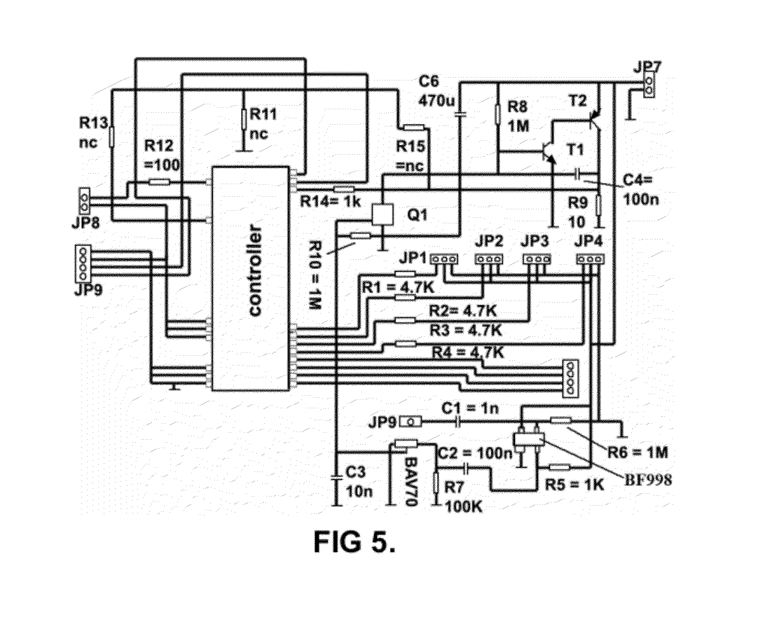

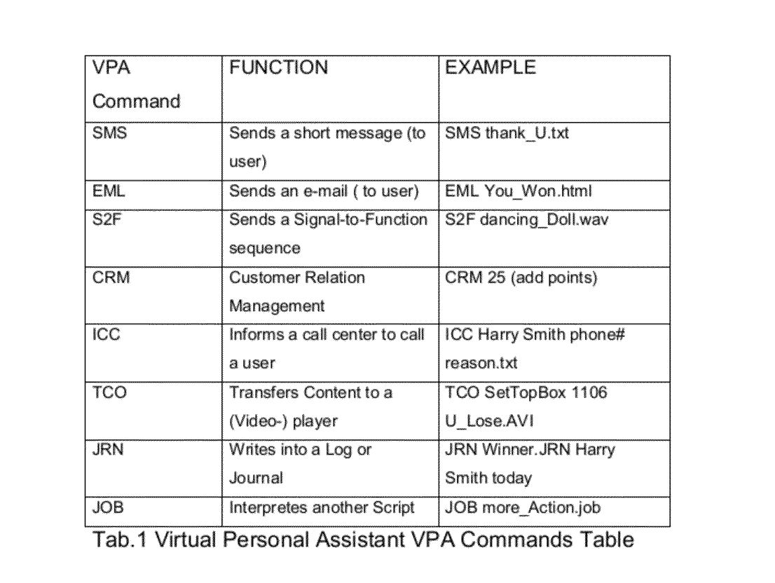

TABLE 1
Virtual Personal Assistant VPA
Commands Table

| VPA | | |
|---|---|---|
| Command | Function | Example |
| SMS | sends a short message (to user) | SMS thank_U.txt |
| EML | sends an e-mail (to user) | EML You_Won.html |
| S2F | sends a Signal-to-Function sequence | S2F |
| | | dancing_Doll.wav |
| CRM | Customer Relationship Management | CRM 25 (add points) |
| ICC | Informs a call center to call an user | ICC Harry Smith |
| | | phone# reason.txt |
| TCO | transfers Content to a (Video-) player | TCO SetTopBox |
| | | 1106 U_Lose.AVI |
| JRN | writes into a Log or Journal | JRN Winner JRN |
| | | Harry Smith today |
| JOB | Interpretes another Script | JOB more_Action.job |

(e) 2010 532, all rights reserved

LISTING 1

```
// ------------------------------------------------------------------//
// Firmware DTS (Dynamic Tracking System) for Toys and Robots
// Version 1.0 (c) R2Z Innovations, all rights reserved
// Author: Wolfgang (Wolf) Richter for R2Z Innovations
// Description: the program generates Electric Fields on
// up to 8 Electrodes direct from an RSC 4128 Controller's
// Port Pins (P2). A hardware Detector D changes the rate of a
// hardware Pulser P related to the Absorption of the E-Field
// A software Counter is running until an Pulse appears.
// A player can change the value by approaching with a hand
// (or Finger) to at least one Electrode E. The program calculates
// the E-Field Difference between all Electrodes and converts
// the result into Servo Movement. So, the Demonstrators head
// can move up&down, left&right. It seems, that the Toy “follows”
// or “reacts” to the Players Hand movements. Special Functions
// can be started at certain hand/finger Coordinates or with S2F Sequences
// An Example is the “Cute Head Banging”
// if the Play comes (close) to the Dog's Eye region.
// ------------------------------------------------------------------//
// The gesture command will be send out in real time to then
// Personal Assistant Portal PAP or to a PC for debugging
// ------------------------------------------------------------------//
#include  <RSC4128.H> // controller specific alignments
#include  <S2F.H>  // signal input and compare routines
#define uint unsigned int
// ------------------------------------------------------------------//
// Test  marker helps for duration checking, using Oscilloscope
#define Marker_on  p1out |=0x01  //  P2.0  as  Marker  for
Debugging/Timing
#define Marker_off p1out &=0xfe  // set to low
// ------------------------------------------------------------------//
//  LED Bar useful for Monitoring the System
#define LED1_on  p1out |=0x02
#define LED1_off  p1out &=0xfd
#define LED2_on  p1out |=0x04
#define LED2_off  p1out &=0xfb
#define LED3_on  p1out |=0x08
#define LED3_off  p1out &=0xf7
#define LED4_on  p1out |=0x10
#define LED4_off  p1out &=0xef
#define LEDs_off  p1out &=0xe1
//-------------------------------------------------------------------//
// System Definitions
#define allHigh 0x0f  // Servo Burst Start Signal
#define first_half for(sdelay=0;sdelay<345;sdelay++) // waits 1ms
#define Steps 5  // Step rate for Servos
#define Drift 8  // Drift Compensation Rate
#define UID AB3D  // User- or Toy ID
// ------------------------------------------------------------------//
// Variables Definition
char synch;  //  ACP Synchronization Marker
char Burst_Xn,S1;  //  Burst Counter X-Left,counts down for Software
PWM
char Burst_Xr,S2;  //  Burst Counter X-Right,counts down for Software
PWM
char Burst_Yn,S3;  //  Burst Counter Y-Left,counts down for Software
PWM
char Burst_Yr,S4;  //  Burst Counter Y-Right,counts down for Software
PWM
const char Low[4] = {0xfe,0xfd,0x0fb,0xf7};  // Matrix to end specific Servo
Pulse
char Pause;  //  used to fill up the Servo Move Routine to exact 1ms
char i,s;  //  Interval Variable
int sdelay;  //  used for fine tuning Servo Timing
const char Electrode[4] = {0x10,0x20,0x40,0x80};  // = E
const char Elow[4]  = {0xef,0xdf,0xbf,0x7f};  //
uint Sense[4],SenseBase[4],Range[4];  //
const float Multiplier[4] = {1000.0,2000.0,2000.0,1000.0};
uint Interval;  // counts until Pulser interrupts
uint Result;  //
// ------------------------------------------------------------------//
// Function prototypes (API Functions)
uint Sensor(char cse);  // read out the Currently Selected Electrode
(cse)
void move_Servos(void);  // moves 4 Servos at a time
void Debug(uint DeVal,uint Code);  // clocks out a given Value with full
Controller Speed
void shift_out(uint Value);  // Debug supporting Software Shifter
uint calculate(uint a,uint b,float c); // General Formular Calculator A/B*C
void Reach(uint SenseVal,uint Check);  // Can Display Sensitivity on a LED
Bar
// ------------------------------------------------------------------//
void main( )
{
  cmpCtl |= 0x07;  // Comparator off
  p2ctla = 255;  // Prepare I/O for Servo and E-Field Output
  p2ctlb = 255;  // no Pull Up's needed
  p1ctla = 0xdf;  // Prepare I/O general Output,  P1.5 Input for Debug
  p1ctlb = 255;  // no Pull Up's needed
  p1out = 0x00;  // Clear Port
  p0ctla = 251;  // Prepare I/O general Output and P0.2 for Interrupt
  p0ctlb = 255;  // no Pull Up's needed
  rom_0Ws = 0;  // Set no Wait State for access internal ROM (clkExt.7)
  ws = 0;  // Set Wait State divisor for MOVX instructions
  rw = 1;  // Set mode: movx access flash (ExtAdd.4)
//-----------------------------------------------------------------------
// prepare Interrupt Function related to Absorption Pulsegenerator
  _cli_( );  // lock Interrupts
  IMR=64;  // set the Interrupt Mask for I6 (P2.0)
//-----------------------------------------------------------------------
// Main Loop sets the 4 Servos, generates alternate E-Fields with >135kHz
// and counts an Interval until interrupted by the Absorption Pulser
  S1=50;  // Set X Servo to the Middle
  S3=50;  // Set Y Servo to the Middle
  LED1_on;  // Lamp Test LED1
  Result=Sensor(0);  // Generate E-Field and measure it on Toy's Nose
  LED2_on;  // Lamp Test LED2
  Result=Sensor(1);  // Generate E-Field and measure it on Toy's Right
Head
  LED3_on;  // Lamp Test LED3
  Result=Sensor(2);  // Generate E-Field and measure it on Toy's Forehead
and Upper Skull
  LED4_on;  // Lamp Test LED4
  Result=Sensor(3);  // Generate E-Field and measure it on Toy's Left Head
//----------------------------------------------------------------------
while(1)  // main loop, loops all the jobs
{
for(s=0;s<4;s++)  //  Select Next Electrode, Sense Value and Factors
  {
  check_S2F( );  // listens and comares signals from the microphone
input
  move_Servos( );  // generate the PWM Signal for 4 Servos simultan
  Sense[s]=Sensor(s);  // get the next E-Field Value
  if(Sense[s]>SenseBase[s])  SenseBase[s]=Sense[s];  //  find  particular
E-Field Maximum
  Sense[s]=SenseBase[s]−Sense[s];  // Calculate the Absorption
  if(Sense[s]>Range[s]) Range[s]=Sense[s]; //  Determine the Play range
  Sense[s]=calculate(Sense[s],Range[s],Multiplier[s]);  //  calculate  the
Relative Absorption Value
  Send2PAP(Sense[s],s);  // monitor the Value or send it to the PAP/VPA
  if(Sense[1]>Sense[3] && Sense[1]>20)  // set X Range when Treshold
(now 20) is higher
    {
    S1+=Steps;  // X Servo Incremental (now 5) with
Speed,Smoothness
    }
  else
  if(Sense[3]>Sense[1] && Sense[3]>20)
    {
    S1−=Steps;  // X Servo Decremental (now 5) with
Speed,Smoothness
    }
  if(Sense[2]>Sense[0] && Sense[2]>20)  // set Y Range
    {
    S3+=Steps;  // Y Servo Incremental (now 5) with
Speed,Smoothness
    }
  else
  if(Sense[0]>Sense[2] && Sense[0]>20)  // Threshold = (now) 20
    {
    S3−=Steps;
    }  // Y Servo Incremental (now 5) with
Speed,Smoothness
  SenseBase[s]−=Drift;  // R2Z's (c) Smart Drift Compensation
SDC
  }
}
}
//----------------------------------------------------------------------
// Universal Calculation Routine (A/B)*c
uint calculate(uint a,uint b,float c)
{
  float calc;
  calc=a*c;  // this Term has to come first
  calc/=b;  // now the Division
  return (uint) (calc);  // convert and return Result
}
//----------------------------------------------------------------------
// Sensing the E-Field on a selected Electrode
unsigned int Sensor(char cse)
{
//----------------------------------------------------------------------
// synchronize with the Absorption Controlled Pulse Generator (ACP)
  synch=55;  // set a Reference
  p02_int = 0;  // clear Interrupt Mask
  _sti_( );  // allow Interrupts
  while(synch>0);  // and wait until it happens
// now generate alternating E-Field (150kHz) for the Electrode pin,
//  c11se points to. The Detector will generate a DC Voltage related to the
field's
// strength which goes lower the more an users hand aproaches (Absorption)
//  p1ctla=Electrode[cse] + 0xf0; // High Impedance for unselected Electrodes
//
  synch=222;
  for(Interval=0;synch>0;Interval++) // count up until Pulse occures
  {
  p2out\hat{ }=Electrode[cse];  // toggle current Electrode
  }
  _cli_( );  // lock Interrupts
  p2out&=Elow[cse];  // Ground Electrode after Work
  return Interval;
}
//--------------------------------------------------------------------------
// Display Sensitivity
void Reach(uint SenseVal,uint Check)  // LED Bar
{
LEDs_off;
if(SenseVal>Check*16)  LED4_on;
else
if(SenseVal>Check*8)  LED3_on;
else
if(SenseVal>Check*4)  LED2_on;
else
if(SenseVal>Check*2)  LED1_on;
}
//--------------------------------------------------------------------------
// PWM Servo Control
void move_Servos( )  // controlls 4 Servos all together synchrone
{
Marker_on;
if(S1<10) S1=10;// limit the Servo Movement
if(S1>90) S1=90;// X-Axis stays in range
if(S3<10) S3=10;// limit the Servo Movement
if(S3>90) S3=90;// Y-Axis stays in range
S2=100−S1;  // Reverse Output for “Escape” effect
S4=100−S3;
Burst_Xn=S1;  // Load Burst selected Counter
Burst_Xr=S2;
Burst_Yn=S3;
Burst_Yr=S4;
//--------------------------------------------------------------------------
// the Servo Control Subroutine works in Percentage Steps, since the
// Controller's Hardware PWM is reserved for the Voice/Sound output
p2out |= allHigh;  // set all Servo Ports to log. 1
first_half;  // just wait 1ms
Marker_off;
i=100;
while(i−−)  // 1ms Setting Loop
    {
    for(Pause=0;Pause<4;Pause++)  // Servo Time alignment
      {
        #pragma asm NOP
        #pragma asm NOP
      }
    if(--Burst_Xn==0) p2out&=Low[0];  // count down Burst for Servo X-Left
    if(--Burst_Xr==0) p2out&=Low[1];  // count down Burst for Servo X-Right
    if(--Burst_Yn==0) p2out&=Low[2];  // count down Burst for Servo Y-Left
    if(--Burst_Yr==0) p2out&=Low[3];  // count down Burst for Servo Y-Right
    }
  p2out&=0xf0;  // don't allow overlength Bursts
}
//--------------------------------------------------------------------------
//  a  Pulse  from  the  ACP  (=P)  unit  causes  an  Interrupt 6.  The  Subroutine
stores
// the current Interval Counter value in the related Calculation Variable
// pointed out by cse
#pragma interrupt 6 Pulse //  Interrupt 6 (Pin 0.2 )
void Pulse(void)  //  Interrupt on positive edge of the Pulsegenerator
{
  p02_int = 0;  //  prepare for the next Interrupt
  synch = 0;  //  clear Sychronization Marker
}
//--------------------------------------------------------------------------
// Real Time synchronized Interface
// Shifts out (MSB) a 16 bit value stored in Variable DeVal
// Version for slow Host (Parallax Propeller Test Bench)
// this data can be send to tele-interactive networks via
// the Personal Assistant Portal PAP
void Send2PAP(uint DeVal,uint Code)  // Synchronized Data Transfer to
Portal PAP
{
  if((p1in & 0x20) == 0x20) // Check if Debug Host is ready
    {
    shift_out(Code);  // transfer Action Code
    shift_out(ID);  // transfer User- or Toy ID
    shift_out(DeVal); // transfer Debug or Feedback Value
  }
}
void shift_out(uint Value)
{
            // show Host that there is something
    for(i=0;i<16;i++)  // shift out num_bits of Value
      {
      if((Value & 0x8000)== 0x8000) // check if MSB is log. high
        { p1out |= 0x80; }  // bit appears on I/O Port 1, Pin 7
      else
        { p1out &= 0x7f; }  // bit cleared on Port 1 Pin 7
      p1out |= 0x40;
          Value <<= 1;  // prepare to test next bit in Value
          p1out &= 0xbf;  // Zero Signal on P1.6
          }
}
// END.
```

What is claimed is:

1. Systems and methods for tele-interactive toys that react to sequences transmitted via broadcasting or networks.

2. According to claim 1: hardware and software for sending feedback into networks on communication systems while interacting with toys, games, action figures, pawns or other devices.

3. Underlying claims 1 and 2: a gesture recognition system that allows to recognize movements from fingers or limbs of at least one user

4. According to claims 1, 2, and 3: methods for activating mechatronic parts based on at least one user's gesture or to transmit gesture related signals to outside networks or communication systems.

5. Interactive energy harvesters that can be charged over physical forces like alternating e-fields, electro-magnetic waves, temperature, vibrations or light, they also detect and signalize the existence of such a force as well as the approximation or touch of a user.

6. A device According to claims 1 and 2, which contains an electronic circuit that is able to react to gestures (touch-less) or on approximation or touch.

7. Software for driving a circuit According to claim 6 for sending identifying or control sequences into networks or communication systems.

8. A personal assistant portal (PAP) According to claim 1, which stores feedback sequences, user data, action scripts, journals, logs or other files.

9. Software “Virtual Personal Assistant” (VPA) that runs temporarily to interpret stored orders related to trigger information coming either from users, computers, broadcast or other sources.

10. A software According to claims 1 and 2 for aligning trigger signals or signal sequences with media content of any kind.

11. According to claims 1 and 2, systems and methods for aligning toys and games with game consoles, set-up boxes, TV screens or other screens.

12. According to claims 1 and 2 for using such a system for sales support in retail shops where customers can interact with toys, games or other goods to react to advertising footage or Customer Relationship Management systems (CRM).

13. Gesture detection preferably attached to a sensor foil that can be integrated into toys, plush dolls, play sets, play- and sports mats or other items used for the invention's underlying purposes.

14. According to claims 1 and 2, methods to detect the arrangement of action figures, game board pawns and other toys or items to each other or to a game set, board game, play- or game situations.

15. Methods of generating identifying- or feedback codes related to activities with toys, games or other items.

16. Methods According to claims 1 and 2 for programming or updating toys and games with sequences for comparison with broadcasted signals integrated into media content.

17. Scripting language for the Virtual Personal Assistant (VPA) interpreter.

18. According to claims 1 and 2, databases that can store such scripts or user or other data, which launches at least one VPA to interpret such script(s) related to activities with toys, games, media content, or other contents or items.

19. Hard- or Software or Methods to integrate or align tele-interactive sequences in or with media content.

20. Systems and Methods to send vital signs from a user into a network, toys, games or other devices.

21. Means according claims 1 and 2 in combination with augmented reality (AR).

22. Systems and methods according to claim 1, 2, 3 used for interactive sales support of toys and games or other goods.
